(19) United States
(12) Patent Application Publication
(10) Pub. No.: US 2024/0076895 A1
(43) Pub. Date: Mar. 7, 2024

(54) TENT WITH CHARGING DEVICE AND WIRING THEREOF

(71) Applicant: HANGZHOU YIXIANG TECHNOLOGY RESEARCH AND DEVELOPMENT CO., LTD., Hangzhou (CN)

(72) Inventors: Baichen DONG, Hangzhou (CN); Yulin YE, Hangzhou (CN); Jianing ZHU, Hangzhou (CN); Chao GU, Hangzhou (CN); Bailin XU, Hangzhou (CN)

(73) Assignee: HANGZHOU YIXIANG TECHNOLOGY RESEARCH AND DEVELOPMENT CO., LTD., Hangzhou, ZJ (CN)

(21) Appl. No.: 18/452,519

(22) Filed: Aug. 18, 2023

(30) Foreign Application Priority Data
Sep. 5, 2022 (CN) 202211079052.3
Sep. 7, 2022 (CN) 202211088535.X
Sep. 9, 2022 (CN) 202211106167.7

(51) Int. Cl. E04H 15/02; E04H 15/50

(52) U.S. Cl. CPC E04H 15/02; E04H 15/50; H02J 7/0042

(57) ABSTRACT

A tent with a charging device and wiring thereof includes a main body that includes a frame and a wall, the frame being connected to the wall. The tent also includes an electrical component, which includes an electrical appliance, a power supply and an electric wire. The electrical appliance and the power supply are electrically connected through the electric wire, and the electrical appliance and the electric wire are detachably or fixedly arranged on the frame and/or the wall. For the tent with a charging device and wiring thereof, electrical appliances and electric wires are reasonably arranged on the frame or the wall of the tent in a fixed or manner, by which layout of electrical appliances and electric wires is more reasonable and regular, and the electrical appliances and electric wires will not occupy activity space in the tent, effectively improving users' experience on tents.

### REFERENCE TO RELATED APPLICATIONS

The present application claims the priorities of Chinese patent application No. 202211079052.3, filed on Sep. 5, 2022, Chinese patent application No. 202211088535.X, filed on Sep. 7, 2022, and Chinese patent application No. 202211106167.7, filed on Sep. 9, 2022, the entire discloses of which are incorporated herein by reference.

### FIELD OF THE DISCLOSURE

The present disclosure relates to the technical field of tents, in particular to a tent with a charging device and wiring thereof.

### BACKGROUND OF THE DISCLOSURE

Tent is a kind of camping and living prefabricated house that is easy to assemble and dismantle, and commonly used in various outdoor activities. The current tent structures are made of frames and tent fabrics. When users travel, they will also carry some electrical appliances, such as portable lights and fan lights. Although some electrical appliances have their own batteries, use time thereof is relatively short, and the electrical appliances are placed on the ground or on the desktop, leading to poor using experience of electrical appliances and unreasonable internal space layout of the tent, which in turn affects users' experience on tents.

### SUMMARY OF THE DISCLOSURE

### I. Technical Problem to be Solved

With respect to the deficiencies of the prior art, the present disclosure provides a tent with a charging device and wiring thereof, which solves the problems raised in the Section “Background Art.”

### II. Technical Solutions

To achieve the above object, the present disclosure is achieved through the following technical solutions: a tent with a charging device and wiring thereof, including a main body with a frame and a wall, the frame being connected to the wall, and also including electrical components that include an electrical appliance, a power supply and an electric wire, the electrical appliance and the power supply being electrically connected through the electric wire, and the electrical appliance and the electric wire are detachably or fixedly arranged on the frame and/or the wall.

Preferably, the frame includes a support member and a hinge, one end of the support member is connected to the wall, the other end of the support member is rotatably connected to the hinge, and there are multiple support members, which are arranged in a circumferential direction of the hinge.

Preferably, the electrical appliance is fixed to the hinge or the support member or the wall, and the electric wire is partly fixed to the wall and partly fixed to the support member.

Preferably, the wall includes a door wall, the frame includes a strut member, which supports the door wall, the electric wire is partly fixed to the strut member or the door wall, and the electric wire is partly fixed to the wall and/or the support member.

Preferably, the electrical component further includes a control unit, which is used to control states of the electrical appliance, and which is fixed to the main body.

Preferably, the control unit and the hinge are integrally arranged, magnetically connected or snap-connected; or the control unit and the support member are integrally arranged, magnetically connected or snap-connected.

Preferably, the control unit includes a remote-control unit with a signal transmitting device, which signal receiving device is provided or connected in the electrical appliance or on the electric wire, and the remote-control unit controls states of the electrical appliance.

Preferably, the electrical appliance is connected to the hinge through a clamping part or a magnetic attractor.

Preferably, the support member is a hollow structure, and the electric wire is at least partially located in the support member.

Preferably, the electrical component includes an electric wire bag, which is located in the main body, and which electric wire bag is fixed to the wall.

### III. Advantageous Effect

The present disclosure provides a tent with a charging device and wiring thereof, bringing about the following advantageous effects:

For the tent with a charging device and wiring thereof, electrical appliances and electric wires are reasonably arranged on the frame or the wall of the tent in a fixed or manner, by which layout of electrical appliances and electric wires is more reasonable and regular, and the electrical appliances and electric wires will not occupy activity space in the tent, effectively improving users' experience on tents.

### BRIEF DESCRIPTION OF THE DRAWINGS

FIG. 1 is a schematic diagram of a three-dimensional assembly of a tent according to an embodiment of the present disclosure;

FIG. 2 is a schematic sectional view along line A-A in FIG. 1;

FIG. 3 is a schematic diagram of a frame structure according to an embodiment of the present disclosure;

FIG. 4 is an enlarged schematic diagram of circle B in FIG. 2;

FIG. 5 is a schematic diagram of fixing electric wires and control units according to an embodiment of the present disclosure;

FIG. 6 is a schematic diagram of fixing electric wires and control units according to another embodiment of the present disclosure;

FIG. 7 is an enlarged schematic diagram of circle C in FIG. 2.

In the FIG.: 1—main body; 2—frame; 21—hinge; 22—support member; 23—strut member; 3—wall; 31—side wall; 311—module part; 32—top wall; 321—plate part; 33—door wall; 34—installation piece; 4—base; 5—electrical component; 51—electric wire; 511—starting end; 512—terminating end; 52—power supply; 53—electrical appliance; 54—control unit; 542—remote-control unit; 542—remote-control bag; 55—wire bag; 551—opening.

### DETAILED DESCRIPTION OF THE EMBODIMENT(S) OF THE DISCLOSURE

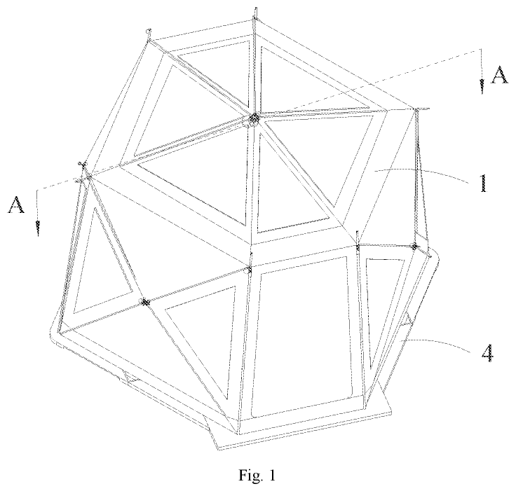

Embodiments of the present disclosure provide a tent with a charging device and wiring thereof. As shown in FIGS. 1-7, the tent includes a main body 1 and a base 4, and the main body 1 is installed on the base 4. The bottom of the main body 1 can wrap the base 4, that is, the area of the horizontal cross-section at the bottom of the main body 1 is greater than the area of the horizontal cross-section of the base 4, and the base 4 is located inside the main body 1. When it rains, rainwater can flow down along the surface of the main body 1 to facilitate water flowing out. Alternatively, the main body 1 can also be entirely located above the base 4. That is, the area of the horizontal cross-section of the bottom of the main body 1 is smaller than the area of the horizontal cross-section of the base 4, and the bottom of the main body 1 is connected to an upper or inner surface of the base 4, which improves connection convenience of the base 4 and the main body 1.

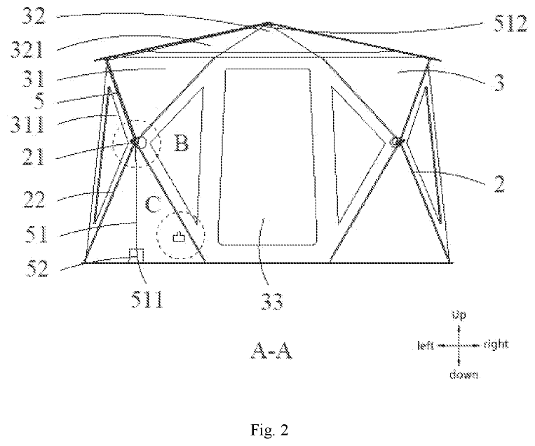

As shown in FIG. 2, the main body 1 includes a frame 2 and a wall 3, and the wall 3 is fixedly connected with the frame 2, that is, the frame 2 supports the wall 3. It can be understood that the frame 2 and the wall 3 can be fixed in a detachable way. For example, the frame 2 is detachably connected to those on the wall 3 such as sleeve, adhesive parts, magnetic attractors, clamping parts, etc., and the connection can also be achieved by the frame 2 clamping the wall 3. Other fixing methods can also be used, such as mutual sewing of the frame 2 and the wall 3, stitching of the frame 2 into the wall 3, or fixing of the frame 2 and the wall 3 through connectors. Of course, it is also possible to detachably connect part of the frame 2 to the wall 3, and fixedly connect part of the frame 2 to the wall 3.

The wall 3 can be made of soft materials, such as cloth, knitted, mesh-like or rubber materials. The wall can also be made of hard materials, such as plastics, wood plates, etc. Of course, some materials could be hard support members, and some could be soft materials, so as to enhance supporting strength of the whole tent.

As shown in FIG. 2, the wall 3 can be composed of a whole piece of cloth. Under support of the frame 2, the wall 3 at least has a side wall 31 and a top wall 32. There is a plurality of side walls 31, for example, four side walls 31, six side walls 31, eight side walls 31, or more side walls 31, to form a tent. The side walls 31 could be provided with a door wall 33. There may be one door wall 33, and may be more, such as two door walls, four door walls, etc. The door walls 33 can be provided separately, for example, one of the side walls 31 is used as the door wall 33, and the door wall 33 is fixedly or detachably connected to other adjacent side walls 31. The door wall 33 can also be formed on the side wall 31 directly. For example, a large opening, vertical, triangular or oval, etc., could be formed on the side wall. Different setting methods can be selected upon demand of users.

Each side wall 42 can be a planar structure from the top wall 43 to the direction of the base 4, such as a vertical plane, or an oblique plane; it can also be a concave-convex structure, such as concave-convex with a curved surface, or concave-convex with a central circle, or Pyramid concave-convex. Each side wall 31 can be formed by an integral side wall 31 or an integral part of the entire wall 3; the side wall can also have a plurality of module parts 311, such as four, which can be spliced by four module parts 311, or can be made of a frame 2 supporting the entire side wall 31 to form four modular parts 311 in appearance. In this embodiment, the side wall 31 is a pyramid shape with the center protruding outwardly, which has four triangular module parts 311. The module part 311 has a horizontal module and a vertical module. The horizontal module can be provided with a yarn window, or a window, etc. The vertical module is used for connection or fastening, and of course, a window can also be provided.

The top wall 32 is formed by the integral top wall 32 or is an integral part of the entire wall 3, and is supported by the frame 2, thereby forming a plurality of plate parts 321 in appearance. The top wall can also be assembled and spliced with a plurality of plate parts 321, such as six plates, etc. The number of the plate parts 321 is the same as the number of the side walls 31. The side walls 31 are connected with the top wall 32. Specifically, the vertical modules of the side walls 31 are connected with the plate parts 321 of the top wall 32.

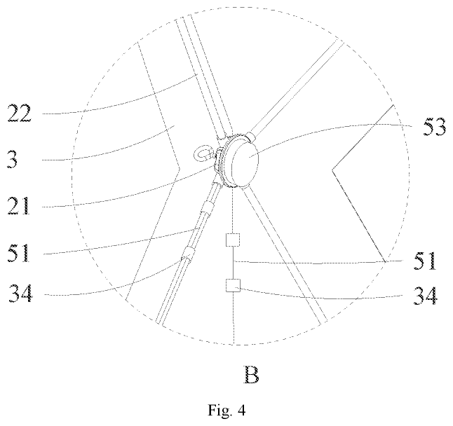

As shown in FIGS. 2 and 4, the tent also has an electrical component 5 connected to the main body 1, and the connection could be a fixed connection, wherein the fixed connection includes a detachable fixed connection, for example, the electrical component 5 is detachably connected to the main body 1. The electrical component 5 includes an electric wire 51, a power supply 52 and an electrical appliance 53. The electrical appliance 52 and the electrical appliance 53 are electrically connected by the electric wire 51. The electrical appliance 53 can use its own battery pack, and can also be used with the power from the power supply 52 through the electric wire 51 or through wireless charge. The power supply 52 is located at the connection between the main body 1 and the base 4, or the power supply 52 is located on the base 4, and the power supply 52 can also be hung on the frame 2. The electrical appliance 53 is located on the main body 1, and it can be connected with the wall 3 or with the frame 2.

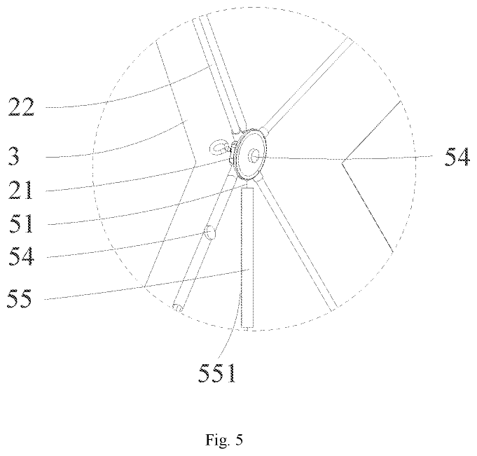

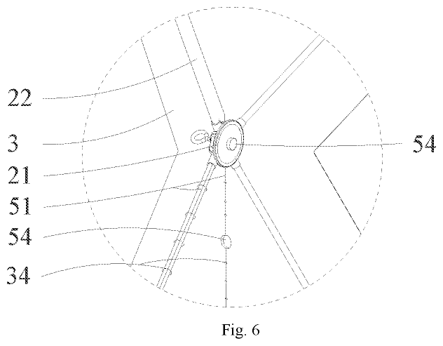

As shown in FIG. 2, FIG. 5 and FIG. 6, the electric wire 51 is partially or entirely located on the wall 3, and the electrical appliance 53 may be located on the top of the main body 1. For example, the hinge 21 at the top wall 32 can also be located at any other place and fixed to the main body 1; the electric wire 51 and the wall 3 may be fixedly connected, wherein the fixed connection may also be a detachable fixed connection. The electric wire 51 can be sewn on the wall 3 by threads or the like so that the electric wire 51 is fixed against the wall 3. The electric wire 51 has a starting end 511 and a terminating end 512. The starting end 511 starts from the joint of the base 4 and the main body 1, extends along the joint of two adjacent side walls 31, then enters the top wall 32, and extends along the joint of two adjacent plate parts 321. The terminating end 512 reaches the highest point of the main body 1. Alternatively, the starting end 511 of the electric wire 51 is located at the joint of the door wall 33 and the side wall 31, and the electric wire 51 extends upward along the joint of the door wall 33 and the side wall 31, then enters the top wall 32, and extends along the two adjacent plate parts 321. The terminating end 512 reaches the highest point of the main body 1. Alternatively, the starting end 511 of the electric wire 51 is located on the module of the side wall 31 or on the door wall 33, that is, it can go up along the joint of the adjacent side wall 31, or it can go up along the joint of the door wall 33 and the side wall 31, or along the side wall 31 and the door wall 33 itself, and then enters the top wall 32, which can extend along the joint of two adjacent plate parts 321. The terminating end 512 reaches the top of the main body 1 and is connected with the electrical appliance 53 of the top wall 32, which can also extend along the plate part 321, and finally reach the electrical appliance 53. It can be understood that the electric wires 51 may also extend between adjacent module parts 311 during the extension thereof on the side wall 31.

The wall 3 is provided with a mounting part 34, which can be semi-circular. The mounting part 34 surrounds the electric wire 51, and both ends of mounting part 34 are fixed with the wall 3, thereby realizing fixing the electric wire 51 onto the wall 3 using the mounting part 34, so that the electric wires 51 are partially or completely located in a channel between the mounting part 34 and the wall 3, which improves the connection stability of the electric wires 51. The mounting part 34 fixes the electric wires 51 on the wall 3, which improves the connection stability of the electric wires 51. For fixing the electric wire 51 using the mounting part 34, the fixation using the mounting part 34 could be done after completion of production of the wall 3, which simplifies the process of production and provides a variety of options of the electric wires 51. Alternatively, the mounting part 34 also can be cloth strip or other soft parts etc. The cloth strip is fixed on the wall 3, and the cloth strip can be sewn on the wall 3. For example, the cloth strip can be sewn at the joint of adjacent side walls 31, or at the joint of the door wall 33 and the side wall 31, or at the module part 311 of the side wall 31, or at the plate part 321 of the top 32, or at the joint of two adjacent plate parts 321, etc. The cloth strip and the wall 3 form a bag channel, in which the electric wires 51 are arranged, for limiting the wiring of the electric wires 51. Alternatively, the mounting part 34 may also be a concave plastic part or other hard material parts, and the electric wires 51 are clamp connected in the concave shape of the plastic part.

Specifically, the electric wire 51 and the wall 3 may also be detachably connected, and the electric wire 51 and the wall 3 are pasted and fixed with an adhesive material. The adhesive material can be arranged along the running direction of the electric wire 51, or can be fixed by multiple adhesive materials. There is a certain distance between adjacent adhesive materials of the multiple adhesive materials, which reduces the consumption of adhesive materials and reduces the cost. Alternatively, a plurality of cloth bags or a plurality of hooks can be fixedly arranged on the wall 3, and a certain distance is kept between adjacent cloth bags or adjacent hooks, thereby reducing the number of cloth bags or hooks and thus lowering the cost of the tent. The starting end 511 or the terminating end 512 of the electric wire 51 passes through the cloth bag channel, the ring hole or the hook hole, etc., which improves installation convenience of the electric wires 51.

Further referring to FIG. 6, it can be understood that the installation part 34 can be a cloth strip, having one side fixedly connected with the wall 3 by such as sewing or integrally forming, and the other side provided with a zipper to the wall 3. During the installation, the zipper between the cloth strip and the wall 3 is opened to arrange the electric wire 51 in the channel between the cloth strip and the wall 3. After the installation is completed, the zipper is closed. Both sides of the cloth strip are provided with a zipper, which forms the channel of the electric wires 50 after the zipper of both sides is closed. The cloth strip is detachable, making it convenient to the replace and clean the cloth strip. Both sides of the cloth strip are sewn with the wall 3, and a zipper is provided in the middle of the cloth strip, allowing the electric wire 51 to be placed in the cloth strip. One side or both sides of the cloth strip is/are connected with the wall 3 through a snap fastener. For example, a male fastener is provided on the cloth strip, and a female fastener is arranged on the wall 3, so that the male fastener and the female fastener cooperate with each other to open the channel of the electric wire 51 formed by the cloth strip and the wall 3 or to detach the cloth strip. Alternatively, there are a plurality of cloth strips and snap fasteners corresponding to each other, wherein adjacent cloth strips keep a distance therebetween, reducing cost of the cloth strips. One or both sides of the cloth strip is/are connected to the wall 3 by Velcro. For example, a male Velcro part is set on the cloth strip, and a female Velcro part is set on the wall 3. The male Velcro part and the female Velcro part are bonded and cooperated with each other to open the cloth strip and the channel of the electric wire 51 formed by the wall 3, or detach the cloth strip. Alternatively, there are a plurality of cloth strips and a plurality of Velcro corresponding to each other, and adjacent cloth strips keep a distance therebetween, which reduces cost of the cloth strips. The electric wire 51 is detachably connected, which facilitates replacement and maintenance of the electric wire 51 and improves using experience of the product. Using the snap fasteners and Velcro makes the installation and detachment easier and more convenient.

It can be understood that the electric wire 51 may be a conductive cloth strip, that is, the cloth strip is provided with a conductive material to realize a conductive function. The conductive cloth strip may have all the above-mentioned wiring methods and all the above-mentioned installation and fixing methods. Meanwhile, the conductive cloth strips can be directly fixed or integrated with the wall 3. The conductive cloth strips can be installed and fixed conveniently, and the installation position has a great degree of freedom, which facilitates the layout of the electrical appliances 53 at any position and improves user experience.

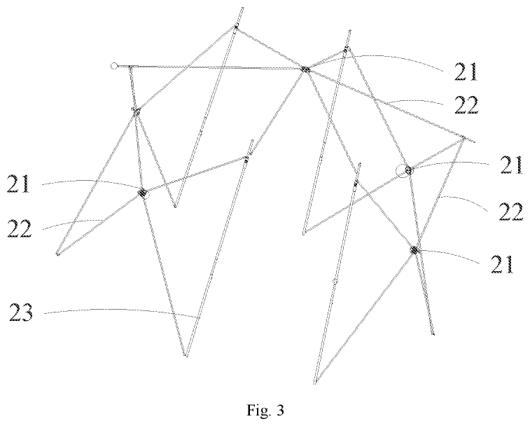

As shown in FIG. 3, the frame 2 includes a strut member 23 located at the door wall 33. The strut member 23 is used to support the door wall 33. The starting end 511 of the electric wire 51 can be fixed with the strut member 23. For example, the electric wire 51 and the strut member 23 are adhesion-fixed by adhesive material, the electric wire 51 is detachably fixed by Velcro surrounding the strut member 23, or the electric wire 51 and the strut member 23 are detachably fixed by cloth strips and snap fasteners. The terminating end 512 passes through the channel of the electric wire 51 formed by the above-mentioned fixing methods and then enters the wall 3, and the above-mentioned fixing method of the electric wire 51 and the wall 3 is adopted after the entry into the wall 3, and finally the terminating end 512 reaches the vicinity of the electrical appliance 53.

The frame 2 also includes a hinge 21 and a support member 22. One end of the support member 22 is rotatably connected to the hinge 21. The support member 22 is arranged in the circumferential direction of the hinge 21. The other end of the support member 22 is fixed to the wall 3, and located at corners of the wall 3. The support member 22 is used to support or fix the side wall 31 and the top wall 32. The electric wires 51 can be routed through the frame 2. For example, the starting end 511 of the electric wires 51 can be set on the support member 22 used for supporting the side wall 31. The electric wires 51 can be fixed along the frame 2 or the frame 2 and the wall 3 can be used together to fix the electric wires 51.

As shown in FIG. 4, FIG. 5 and FIG. 6, specifically, the electric wire 51 and the support member 22 can be adhesion-fixed by adhesive material. Alternatively, the electric wire 51 and the support member 22 can also be detachably fixed by the mounting member 34. The mounting member 34 can be a cloth strip with Velcro, which is laid out around the support member 22. When mounting the electric wire 51, the Velcro is opened. A male Velcro part is provided at one end of the cloth strip, and a female Velcro part is provided on the other end. The two ends of the mounting piece 34 are connected, and electric wire 51 is placed in the cloth strip, so that it could be close to the support member 22 and the electric wire 51 and support member 22 are both located in the circular hole provided on the cloth strip. Then the Velcro is closed to realize the fixing of the electric wire 51 and the support member 22. There could be a plurality of cloth strips, with a certain distance between adjacent cloth strips. The cloth strips can also be set longer to completely wrap the electric wire 51. Similarly, it is also possible to provide a snap fastener for the connection. That is, one end of the cloth strip is provided with a male fastener, and the other end is provided with a female fastener, and a ring is formed by the female fastener and the male fastener to fix the support member 22 and the electric wire 51. It is also possible to provide a clamping part on the support member 22. The clamping part can have one end clamped to the support member 22 and the other end clamped to the electric wire 51. There is a certain distance between adjacent clamping parts. The support member 22 is provided with a ring part or a hook part, and the electric wire 51 passes through the ring part or the hook part and is fixed with the support member 22. The electric wire 51 is detachably connected, which facilitates the replacement and maintenance of the electric wire 51 and improves the user experience of the product.

In some embodiments, both the support member 22 and the strut member 23 are hollow materials, and the electric wires 51 can pass through the inside of the support member 22 and the strut member 23 for wiring. Taking the support member 22 as an example, the strut member 23 can have the same structure: the support member 22 has a hollow hole in the length direction and an electric wire hole in the radial direction, and the hollow hole in the length direction can allow the electric wire 51 to be routed, which can protect the electric wires 51 from collision and extrusion to improve safety of the electric wires 51, and can hide the electric wires 51 to improve the aesthetics. The electric wire holes in the radial direction allow the electric wires 51 to extend from the support member 22. When there is an electrical appliance 53 near the support member 22, the electric wire 51 passes through the electric wire hole or the wire of the electrical appliance 53 passes through the electric wire hole for connection with the electric wire 51, so as to supply power to the electrical appliance 53. The inside of the support member 22 can also be designed with a conductive material, and the support member 22 itself can be used as an electric wire 51. When the electrical appliance 53 is fixed with the support member 22, they can be directly electrically connected.

In some embodiments, referring to FIG. 5, the electrical component 5 includes an electric wire bag 55 located in the main body 1, which, as a part located in the main body 1, can be protected by the wall 3 and the frame 2, reducing the possibility of being exposed to wind and sun, thus prolonging the service life. The electric wire bag 55 is fixed to the wall 3, or is detachably connected. The male part of the Velcro is arranged on the wall 3, so as to realize the fixing of the electric wire bag 55 and the wall 3, and also facilitate the detachment of the electric wire bag 55 from the wall 3, thereby facilitating maintenance and replacement of the electric wire bag 55.

The electric wire bag 55 is provided with an opening 551, at which a zipper, snap fastener, buckle, Velcro or the like can be provided. The electric wire 51 is installed inside the electric wire bag 55 at the opening 551, so that the electric wire 51 is partly or completely located in the electric wire bag 55. The electric wire bag 55 can fix the electric wire 51, and meanwhile can protect the electric wire 51 to reduce wear and tear of its outer skin.

It can be understood that the electric wire bag 55 can also be made of conductive material, and the electric wire bag 55 conducts electricity directly.

In some embodiments, the frame 2 supporting each side wall 31 has at least one hinge 21 and a plurality of support members 22, such as four support members 22; it may also have one hinge 21 and two support members 22, or one hinge 21 and six support members 22, and so on. When the main body of the tent is opened, the hinge 21 protrudes outward, and the support member 22 supports the side wall 31, so that the side wall 31 forms four module parts 311. The support member 22 is made of elastic material, such as fiber material. The hinge 21 is rotationally connected to one end of the support member 22, and the other end of the support member 22 is connected to the wall 3. A plurality of support members 22 on each side wall 31 are evenly arranged in the circumferential direction of the hinge 21, and the support member 22 supports the wall 3, improving the stability of the wall 3.

The frame 2 supporting the top wall 32 has at least one hinge piece 21 and a plurality of support members 22, such as six support members 22. The frame 2 supports the top wall 32, the hinge 21 protrudes upwards, and the support member 22 supports the top wall 32 and makes the top wall 32 form a plate part 321. The number of the support members 22 is consistent with the sum of the number of the side walls 31 and the door walls 33. A plurality of support members 22 on the top wall 32 are arranged in the circumferential direction of the hinge 21, and the support members 22 support the top wall 32, which improves the stability of the top wall 32.

The hinge 21 supporting the top wall 32 can be provided with an electrical appliance 53, such as a lamp, an electric fan, etc. The electrical appliance 53 is fixed with the hinge 21, and can be non-detachably fixedly connected, such as integrally formed or the like, which improves stability of the connection of the electrical appliance 53. The electrical appliance 53 can be fixedly connected with the hinge 21. For example, an LED lamp and an LED lampshade structure are arranged on the hinge 21, and power is supplied to the LED or the like through an internal battery pack of the lamp and an external power supply, or the LED product itself has an independent power supply. The hinge 21 is provided with an electric fan structure, which is driven by a motor energized, which can realize the air circulation in the main body 1 of the tent. Alternatively, a channel of the electric fan communicates inside of the main body 1 and the outside atmosphere, which realizes air ventilation inside the main body 1 and improves the air quality inside the main body 1, improving user experience.

It can be understood that the electrical appliance 53 can be detachably fixedly connected or detachably connected to the hinge 21, and so on. The electrical appliance 53 and the hinge 21 can achieve detachable connection by clamping parts, buckles, magnetic attractors, thread fitting of the electrical appliance and the hinge 21, or the like. For example, a hook is provided on the hinge 21. The hook can be a rotatable structure or a fixed structure. The lamp is provided with a hook or a hole that matches the hook, so as to achieve connection of the lamp and the hinge 21. Of course, the hole can also be provided on hinge 21, to which the hook on the lamp is adapted. Alternatively, the hinge 21 could be provided with a magnetic attractor, and a base of the electrical appliance 53 such as the lamp or the electric fan is also provided with a magnetic attractor, and the two magnetic attractors are fitted so that the electrical appliance 53 such as the lamp or the electric fan is fixedly connected to the hinge 21. Alternatively, the hinge 21 is provided with internal threads or a snap part/snap slot, and the electrical appliance 53 or the base of the electrical appliance 53 is provided with external threads or a snap slot/snap part to match with the structure on the hinge 21, so as to realize the detachable fixation thereof. With the detachable structure, it is convenient to make replacement and maintenance of the electrical appliance 53, and it is also easy to store the tent after it is disassembled. In addition, after disassembled, the above-mentioned electrical appliances 53 can also be used in other scenarios, which meets diversified needs of users. Of course, other connection methods can also be used, such as fixing with viscous materials, or binding with cords, etc. The method of fixing the electrical appliance 53 can be selected according to the convenience of the user himself.

The hinge 21 supporting the side wall 31 can also be provided with an electrical appliance 53, such as a lamp, an electric fan, a projector, a sound system, and the like. The connection mode of the hinge 21 of the side wall 31 and the electrical appliance 53 can be consistent with the connection mode of the hinge 21 and the electrical appliance 53 of the top wall 32, such as a fixed connection, or a detachable connection via clamping parts, buckles, magnetic attractors, and threaded connection of the electrical appliance and the hinge 21, or a connection other than the aforementioned, which could be selected according to user's needs.

The hinge 21 is provided with an electrical appliance 53, which can realize arranging the electrical appliance 53 in the space inside the tent, reducing space occupation on the base 3 and the desktop, improving space utilization rate inside the tent, and allowing to accommodate more electrical appliances 53 in the tent, thereby improving user experience. The structural strength of the hinge 21 on the frame 2 is used to support the electrical appliance 53 so as to improve the stability of the electrical appliance 53.

The hinge 21 supporting the side wall 31 can also be provided with an interface for the electrical appliance 53, such as a USB interface, a type-c interface, an XT interface, a DP interface, an HDMI interface, etc., and also a socket and the like. The interface form of the hinge 21 can be set according to different requirements. The above-mentioned interface can be directly located on the hinge 21 and fixedly mounted on the hinge 21. Alternatively, an electric wire interface can be set from the hinge 21 to realize electrical connection with the electrical appliance 53. When the hinge 21 is provided with a socket, electrical appliances 53 can be fixed around the hinge 21, so that the electric wires of the electrical appliances 53 can be electrically connected to the socket.

It can be understood that the electrical appliance 53 can also be arranged on the support member 22 that supports the top wall 31 or the side wall 32. For example, the support member 22 is provided with a clamping part, a magnetic attractor, a hook, or some soft or hard ring parts corresponding to the electrical appliance 53, which improves convenience of connecting the frame 2 and the electrical appliance 53 and also improves space layout reasonability of the electrical appliance 53 in the main body 1. The wiring layout of the electric wires 51 can be arranged on the wall 3 or the frame 2, and when the electrical appliances 53 are connected to the support member 22, the terminating ends 512 of the electric wires 51 can also be electrically connected to the electrical appliances 53. Alternatively, the electrical appliances 53 can also be arranged on the wall 3, that is, the electrical appliances 53 are connected to the wall 3, with the connection mode consistent with that of the electrical appliance 53 and the support member 22. For example, clamping parts, magnetic attractors, hooks, cloth bags or the like are correspondingly sewn to the wall 3 for connection with the electrical appliances 53, providing another way for the layout of the electrical appliances 53 in the main body 1, which improves the reasonability of the internal space layout of the main body 1, increases diversity of layout selections of user's electrical appliances 53 and thus improves the user experience. The electrical appliances 53 can be energized through the electric wires 53 routed on the wall 3, and can also be energized through conductive cloth.

Of course, non-electrical components can also be provided on the hinge 21 of the frame 2, the support member 22, the strut member 23, or the wall 3. For examples, hooks or magnetic attraction base or the like could be provided on the hinge 21, the support member 22, and the strut member 23 for fixing mobile phones, water cups, remote-control units 541, projection screens or other tools for use.

The electrical appliances 53 can be powered on and off by being directly plugged from the interface, and can also be turned on and off or have its state changed by the control unit 54. The control unit 54 can be provided on the hinge 21. For example, the hinge 21 is provided with a knob structure, which is turned to achieve the change of state of the electrical appliances 53. The knob structure can be integrated with the hinge 21. For example, turning a knob on the top or circumference of the hinge 21 could control the electrical appliances 53. Also, a touch switch could be provided on the hinge 21 to achieve on-and-off control by clicking or sliding on the surface of the hinge 21, touching the hinge 21 with one/two fingers, and so on. Also, an inductive switch with, for example, sound-activated induction and light-controlled induction could be provided on the hinge 21, so that when a user leaves the main body 1 of the tent, the on-and-off control of the electrical appliances 53 is realized through infrared induction; or a mechanical button, a pull rope knob or the like could be used for on-and-off control of the electrical appliances 53.

Specifically, the control unit 54 of the hinge 21 is used to control the light structure. The control unit 54 can be a knob structure to turn on and turn off the light, adjust brightness of the light or color of the light. Alternatively, with rotation of the knob structure to different angles, the knob structure on one hinge 21 can control on-and-off, brightness and color of the light, etc. It could be understood that the knob structure could be used for control of such electrical appliances as electric fans, projectors, stereos, and air conditioners. For example, the knob structure could be used to control on-and-off, rotational speed and wind speed of the electric fan and the like. Alternatively, the control unit 54 can also be a touch switch structure, which can be controlled by a single click to turn on or off the light, double-click to control the color of the light, and slide to control brightness of the light, etc. Alternatively, the control unit 54 can also be an inductive switch to control the on-and-off of the light through, for example, infrared rays and voice control. When a person is inside the main body 1, the light is on, and after a period of time, it turns off automatically, and can be turned on again by voice control. Control of other electrical appliances 53 can be achieved by the same way.

The control unit 54 can be arranged on the support member 22 or the strut member 23, and the control unit 54 is clamped or fixedly connected with the support member 22 or the strut member 23. For example, the control unit 54 could achieve fixation and connection by adhesive parts, clamping parts, magnetic attractors, hooks or some soft or hard ring parts. Another example is that the control unit 54 can be set as a knob structure, and the knob structure and the support member 22 or the strut member 23 are clamped by a clamping part. The switch of the light can be provided on the strut member 23 to facilitate a user turning on the light before entry into the main body 1, and the switch can also be on the support member 22 near the sleeping bag to facilitate a user to control the switch of the light. The switch of the light can also be fixed to the support member 22 or the strut member 23 by other connection methods. Another example is that the control unit 54 can be set as a touch switch, which is embedded in or act as a part of the support member 22 or the strut member 23. When the user touches in the length direction of the support member 22 or the strut member 23, the capacitance of the touch switch is changed to control on-and-off, brightness of the light, etc. The control can also be single-click or double-click mode control. At this time, the wiring of the electric wire 51 can be arranged inside the frame 2 to connect the touch switch. It can be understood that various control units 54 of other electrical appliances 53 can also be fixed to the support member 22 or the strut member 23 in the above-mentioned method, and the position of the control units 54 can be selected by users.

The control unit 54 can be arranged on the wall 3, and the control unit 54 can be directly sewn on the wall 3 or can be connected in the same way as the support member 22. The electric wires 51 can be routed on the wall 3. There may be multiple fixed positions of the control unit 54 on the wall 3, which could be the ones convenient for users' use. It can be understood that the control structure and control mode of the control unit 54 are the same as those described above, which will not be repeated here.

The clamping part not only allows the electrical appliance 53 or the control unit 54 to be detachably connected, but also makes the fixing of the electrical appliance 53 and the control unit 54 more stable by clamping fixation. The hook part makes the installation and disassembly of the electrical appliance 53 or the control unit 54 more convenient, and can be disassembled and installed at will, which greatly facilitates the replacement and storage of the electrical appliance 53 and the control unit 54 by users. The magnetic attractor can make the electrical appliance 53 or the control unit 54 more stable, and it is easy to disassemble and assemble the same.

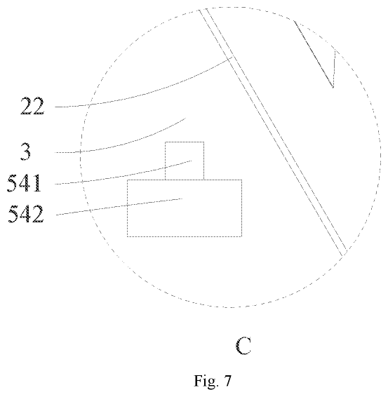

As shown in FIG. 7, the control unit 54 can be a remote-control device having a remote-control unit 541 with a signal generating function and a receiving module with a signal receiving function. For example, a light with the receiving module could have its on-and-off, color, brightness, timing or the like controlled by the remote-control unit 541 controlling the receiving module. The receiving module can be directly installed in the light, or can be arranged on the hinge 21, or on the wiring line of the electric wire 51, etc. The position of the receiving module can be set according to users' experience. The installation position of the remote-control unit 541 can be located at the hinge 21, the support member 22, the strut member 23, or the cloth bag sewn to or detachable from the wall 3. The method of mounting the remote-control unit 541 to the frame 2 or the wall 3 is consistent with or similar to the various installation methods mentioned in the present disclosure, such as clamping connection, magnetic connection and the like. It can be understood that the position where the control unit 54 is installed can also be the position of the electrical appliance 53, or vice versa.

The control unit 54 has a remote-control bag 542, which can be sewn on the wall 3 or detachably connected to the wall 3 through Velcro, snap fasteners, etc., or connected to the frame 2 by the same connecting method in the present disclosure. The remote-control unit 541 can be placed in the remote-control bag 542, which improves the layout of the electrical appliances in the tent, facilitates users storing the remote-control unit 541, and makes it convenient for users to use.

In some embodiments, a light strip or a luminous substance is provided at the connection between the main body 1 and the base 4, and the light strip can have the effect of repelling mosquitoes, such as emitting light that mosquitoes are afraid of A light strip is set on the frame 2 to realize the luminous effect of the whole frame, or the light strip passes through the strut member 23 made of a transparent material, so that the strut member 23 emits light. Alternatively, the light strip is embedded in the strut member 23 and the support member 22 to realize the light emitting of the frame 2. The hinge 21 can also be embedded in the light strip, or the hinge 21 could be a transparent part that can transmit the light emitted by the light strip. A light strip can also be arranged on the wall 3. It can be understood that the light is also a kind of electrical appliance 53.

In other embodiments, the electrical appliance 53 may have its own battery pack, and the state of the electrical appliance 53 is controlled through its own switch. Certainly, the fixing method of the electrical appliance 53 is consistent with the above-mentioned several embodiments.

Although the embodiments of the present disclosure have been shown and described, those skilled in the art can understand that various changes, modifications, substitutions and variations can be made to these embodiments without departing from the principle and spirit of the present disclosure. The scope of the present disclosure is defined by the appended claims and their equivalents.

1. A tent with a charging device and wiring thereof, comprising a main body with a frame and a wall, the frame being connected to the wall, wherein it further comprises an electrical component that includes an electrical appliance, a power supply and an electric wire, the electrical appliance and the power supply are electrically connected through the electric wire, and the electrical appliance and the electric wire are detachably or fixedly arranged on the frame and/or the wall.

2. The tent with a charging device and wiring thereof according to claim 1, wherein the frame comprises a support member and a hinge, one end of the support member is connected to the wall, the other end of the support member is rotatably connected to the hinge, and there are multiple support members, which are arranged in a circumferential direction of the hinge.

3. The tent with a charging device and wiring thereof according to claim 2, wherein the electrical appliance is fixed to the hinge or the support member or the wall, and the electric wire is partly fixed to the wall and partly fixed to the support member.

4. The tent with a charging device and wiring thereof according to claim 2, wherein the wall includes a door wall, the frame includes a strut member, which supports the door wall, the electric wire is partly fixed to the strut member or the door wall, and the electric wire is partly fixed to the wall and/or the support member.

5. The tent with a charging device and wiring thereof according to claim 2, wherein the electrical component further includes a control unit, which is used to control states of the electrical appliance, and which is fixed to the main body.

6. The tent with a charging device and wiring thereof according to claim 5, wherein the control unit and the hinge are integrally arranged, magnetically connected or snap-connected; or the control unit and the support member are integrally arranged, magnetically connected or snap-connected.

7. The tent with a charging device and wiring thereof according to claim 6, wherein the control unit includes a remote-control unit with a signal transmitting device, which signal receiving device is provided or connected in the electrical appliance or on the electric wire, and the remote-control unit controls states of the electrical appliance.

8. The tent with a charging device and wiring thereof according to claim 3, wherein the electrical appliance is connected to the hinge through a clamping part or a magnetic attractor.

9. The tent with a charging device and wiring thereof according to claim 2, wherein the support member is a hollow structure, and the electric wire is at least partially located in the support member.

10. The tent with a charging device and wiring thereof according to claim 2, wherein the electrical component includes an electric wire bag, which is located in the main body, and which electric wire bag is fixed to the wall.
